(19) United States
(12) Patent Application Publication
(10) Pub. No.: US 2020/0406558 A1
(43) Pub. Date: Dec. 31, 2020

(54) THREE-DIMENSIONAL SHAPING APPARATUS AND THREE-DIMENSIONAL SHAPING METHOD

(71) Applicant: CANON KABUSHIKI KAISHA, Tokyo (JP)

(72) Inventor: Soma Nakai, Machida-shi (JP)

(21) Appl. No.: 16/906,218

(22) Filed: Jun. 19, 2020

(30) Foreign Application Priority Data
Jun. 26, 2019 (JP) 2019-118700

(51) Int. Cl. B29C 64/393; B33Y 10/00; B33Y 30/00; B33Y 50/02; B28B 1/00; B22F 3/00; B29C 64/165

(52) U.S. Cl. CPC B29C 64/393; B33Y 10/00; B33Y 30/00; B29C 64/165; B28B 1/001; B22F 3/008; B33Y 50/02

(57) ABSTRACT

A three-dimensional shaping apparatus includes a powder layer forming part to form a powder layer made from base particles, a liquid applying part to apply liquid to bind the base particles to an area to be shaped in the powder layer in which a shaped article is formed based on three-dimensional data of the shaped article, a controlling part to control the powder layer forming part and the liquid applying part to repeat formation of the powder layer and application of the liquid, and a determining part to determine based on the three-dimensional data in each repeat of the formation of the powder layer and the application of the liquid whether the area to be shaped is present in the powder layer. The controlling part changes control over the powder layer forming part and the liquid applying part based on a determination by the determining part.

### BACKGROUND OF THE INVENTION

### Field of the Invention

The present invention relates to a three-dimensional shaping apparatus to shape shaped articles using a base particle, and to a three-dimensional shaping method of shaping the same.

### Description of the Related Art

Attention has been paid to layering shaping methods wherein a base particle is layered according to slice data of a three-dimensional model to be shaped, as a method of shaping three-dimensional shaped articles.

Japanese Patent Application Publication No. 2015-205485 proposes a technique of forming a shaped article by alternately repeating: a powder layer forming step of leveling a powder material over a build stage that is lowered by a layer pitch to form a powder layer; and a liquid applying step of applying a liquid to the formed powder layer based on slice data of a shaped article. Japanese Patent No. 6194043 proposes a technique of changing the speed of forming a powder layer between the inside and the outside of an area to be sintered in the powder layer.

Unfortunately, a shaping time may be longer even when any of the foregoing techniques is used because the same process as for a powder layer including a shaped article is also carried out on a powder layer not including a shaped article, that is, an unnecessary process is performed.

The present disclosure was made with the foregoing in view, and provides a technique that can achieve a shorter processing time for three-dimensional shaping.

### SUMMARY OF THE INVENTION

According to an aspect, it is provided a three-dimensional shaping apparatus including:

a powder layer forming part configured to form a powder layer made from base particles;

a liquid applying part configured to apply liquid to bind the base particles to an area to be shaped in the powder layer in which a shaped article is formed based on three-dimensional data of the shaped article;

a controlling part configured to control the powder layer forming part and the liquid applying part to repeat formation of the powder layer and application of the liquid to form the shaped article in laminated powder layers; and

a determining part configured to determine based on the three-dimensional data in each repeat of the formation of the powder layer and the application of the liquid whether the area to be shaped is present in the powder layer, wherein the controlling part changes control over the powder layer forming part and the liquid applying part based on a determination by the determining part in each repeat of the formation of the powder layer and the application of the liquid.

According to another aspect, it is provided a three-dimensional shaping method including:

a powder layer forming step of forming a powder layer made from base particles;

a liquid applying step of applying liquid to bind the base particles to an area to be shaped in the powder layer in which a shaped article is formed based on three-dimensional data of the shaped article;

a controlling step of controlling the powder layer forming step and the liquid applying step to repeat formation of the powder layer and application of the liquid to form the shaped article in laminated powder layers; and

a determining step of determining based on the three-dimensional data in each repeat of the formation of the powder layer and the application of the liquid whether the area to be shaped is present in the powder layer,

wherein the controlling step changes control over the powder layer forming step and the liquid applying step based on a determination by the determining step in each repeat of the formation of the powder layer and the application of the liquid.

According to yet another aspect, it is provided a non-transitory computer readable storage medium having a program stored therein, the program causing a computer to execute:

a powder layer forming step of forming a powder layer made from base particles;

a liquid applying step of applying liquid to bind the base particles to an area to be shaped in the powder layer in which a shaped article is formed based on three-dimensional data of the shaped article;

a controlling step of controlling the powder layer forming step and the liquid applying step to repeat formation of the powder layer and application of the liquid to form the shaped article in laminated powder layers; and

a determining step of determining based on the three-dimensional data in each repeat of the formation of the powder layer and the application of the liquid whether the area to be shaped is present in the powder layer,

wherein the controlling step changes control over the powder layer forming step and the liquid applying step based on a determination by the determining step in each repeat of the formation of the powder layer and the application of the liquid.

Further features of the present invention will become apparent from the following description of exemplary embodiments with reference to the attached drawings.

### BRIEF DESCRIPTION OF THE DRAWINGS

FIG. 1 is a schematic view illustrating structure of a three-dimensional shaping apparatus according to the first embodiment;

FIG. 2 is a schematic view illustrating a state of powder layers during shaping according to the first embodiment;

FIG. 3 is a flowchart illustrating a shaping operation of the three-dimensional shaping apparatus according to the first embodiment;

FIG. 4 is a schematic view illustrating a state of powder layers during shaping according to the second embodiment; and

FIG. 5 is a flowchart illustrating a shaping operation of a three-dimensional shaping apparatus according to the second embodiment.

### DESCRIPTION OF THE EMBODIMENTS

Hereinafter, preferred embodiments of the present disclosure will be described with reference to the drawings. Dimensions, materials, shapes, relative positions of components, etc., described below should be appropriately changed according to structure of equipment to which the invention is applied, and various conditions. The scope of the present invention is thus not intended to be limited to the following description. Any well-known or known technique in the art may be applied to structures and steps which are not particularly shown or described. Overlapped descriptions may be omitted in some cases.

The present disclosure relates to a technique of making three-dimensional shaped articles using a particulate material (hereinafter also referred to as a base particle). Thus, the apparatus or the method herein disclosed is recognized as a three-dimensional shaping apparatus referred to as an additive manufacturing (AM) system, a three-dimensional printer, a rapid prototyping system, or the like, or a method of controlling the same, or a three-dimensional shaping method.

The three-dimensional shaping apparatus according to the technique disclosed herein encompasses an apparatus to form shaped articles by alternately repeating: a powder layer forming step of leveling a base particle as a powder material over a build stage to form a powder layer; and a liquid applying step of applying a liquid to the powder layer based on three-dimensional data of the shaped article. In this case, a powder of a resin, a metal, a ceramic, or the like is preferably used for the base particle. A binding liquid to bind the base particle, a particle-dispersed solution in which nanoparticles are dispersed, or the like is preferably used as the liquid applied to the powder layer.

The “a shaped article” used herein is typically intended to mean a three-dimensional shaped article to be shaped. The three-dimensional data of the shaped article includes shape data and slice data of a three-dimensional shaped article. The shaped article does not necessarily have high strength, and encompasses something to which the liquid is three-dimensionally applied according to the shape thereof. A thing obtained by solidifying a part to which the liquid is applied by means of drying or heating, and removing an unsolidified area is also referred to as the shaped article. The shaped article also encompasses something obtained by further carrying out heat treatment and sintering to increase strength thereof.

### First Embodiment

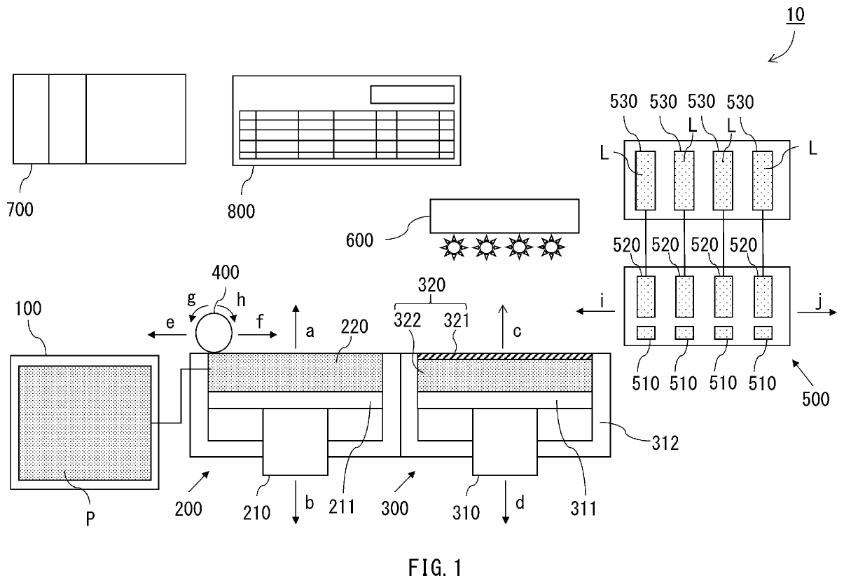

FIG. 1 is a schematic view illustrating structure of a three-dimensional shaping apparatus 10 according to the first embodiment. The three-dimensional shaping apparatus 10 has a base particle tank 100, a base particle supplying part 200 that includes a supplying stage 210 and a supplying table 211 of the base particle, and a build part 300 that includes a build stage 310, a build table 311 and a build chamber 312. The three-dimensional shaping apparatus 10 further has a powder layer forming part 400, a liquid applying part 500 that includes a liquid applying heads 510, liquid auxiliary tanks 520 and liquid tanks 530, a drying part 600, a controlling part 700, and an operating part 800. These parts are arranged in a housing of the three-dimensional shaping apparatus 10. The three-dimensional shaping apparatus 10 may have a sintering furnace to heat and sinter a shaped article M in, or separately outside the housing thereof.

Shaped Article M

The shaped article M is not a part of the components of the three-dimensional shaping apparatus 10 of the technique herein disclosed, but will be described below. The shaped article M is the resultant of the present embodiment which is obtained by applying a liquid L to a base particle P described later to three-dimensionally solidify the base particle P. The shaped article M may be further subjected to heat treatment to improve strength thereof. The three-dimensional data of the shaped article M may be stored in the three-dimensional shaping apparatus 10 in advance, and may be acquired by the three-dimensional shaping apparatus 10 from the outside. The three-dimensional data of the shaped article M includes shape data of the shaped article M, and information indicating the type and the average particle diameter of the base particle, a layer pitch, the type of the liquid, the amount of applying the liquid, etc. An user of the three-dimensional shaping apparatus 10 can operate the operating part 800, to select and determine the type and the average particle diameter of the base particle, a layer pitch, the type of the liquid, the amount of applying the liquid, etc. Desirably, the size, the position, the number, etc. of the shaped article M included in the three-dimensional data can be easily changed.

Base Particle P

The base particle P is used for forming the powder layer when the shaped article M is shaped. A powder of a resin, a metal or a ceramic is used for the base particle P. The base particle P may be a powder of a metal alloy, a powder of a metal to which a non-metallic element such as carbon is added such as carbon steel, a composite powder of a plurality of metals, or a composite powder of a plurality of ceramics.

It is important that the average particle diameter of the base particle P is enough small for improving the density and strength of the shaped article M. Generally, a classified fine particle is used for three-dimensional shaping. It is also important that the flowability of the base particle P is high when the powder layer is formed, which will be described later. A base particle having high flowability is required for improving the quality of the shaped article. Thus, an almost spherical powder having a small average particle diameter is used for the base particle P. Since the flowability of the base particle P varies according to humidity, the base particle P before shaping is desirably stored in a dry environment, and a drying state of the base particle P is also kept during shaping.

The average particle diameter of the base particle P is preferably a size such that the base particle P does not aggregate. Specifically, it is better that the average particle diameter of the base particle P on a volume basis is selected from the range of at least 1 μm and not more than 500 μm, and is preferably selected from the range of at least 1 μm and not more than 100 μm. The average particle diameter of the base particle P of at least 1 μm suppresses aggregation of the base particle P when the powder layer is formed, to make it easy to form a powder layer of few defects. The base particle P may contain plural powders having different average particle diameters.

For example, a first group powder having a relatively large average particle diameter is mixed with a second group powder having a relatively small average particle diameter, which causes the second group powder to get into the first group powder when the powder layer is formed, to make it possible to reduce voids in the powder layer. At this time, the average particle diameter of the second group powder is preferably not more than 0.41 times as large as the average particle diameter of the first group powder. Setting the ratio of the average particle diameter of the first group powder and the average particle diameter of the second group powder as the foregoing makes it possible to arrange the second powder in particle gaps (hexagonal site) when the first powder forms a close-packed structure. This makes it possible to make the atomic packing factor of the powder layer as large as possible, and as a result, a shaped article of a small porosity can be made. The material of the first powder is preferably the same as, but may be different from the second powder.

The average circularity of the base particle P is preferably at least 0.94, and more preferably at least 0.96. The average circularity of the base particle P at least 0.94 can suppress a phenomenon of point contact of the powders containing the base particle P with each other. This improves the flowability of the first powder containing the base particle P, to easily close-pack the base particle P when the powder layer made from the base particle P is formed, which makes it possible to more easily form a powder layer having few voids.

Base Particle Tank 100

The base particle tank 100 includes a base particle cartridge not shown into which the base particle P is packed. A user inserts the base particle cartridge into the three-dimensional shaping apparatus 10 to install the base particle cartridge. The base particle P in the installed base particle cartridge is fed from the base particle tank 100 to the base particle supplying part 200, which will be described later, and is stored as a base particle P 220 to be supplied. The remaining amount of the base particle P in the base particle cartridge is desirably at least the volume of the base particle P necessary for one cycle of shaping. Further, a plurality of the base particle cartridges can be desirably inserted into the base particle tank 100. When the remaining amount of the base particle P in the base particle cartridge is less than the volume necessary for one cycle of shaping, a user supplements the base particle P during shaping by exchanging the base particle cartridges, or the like. Thus, the three-dimensional shaping apparatus 10 desirably has a function of informing a user of the remaining amount of the base particle P in each base particle cartridge.

As the foregoing, it is necessary for the base particle P to be stored in a dry environment. Generally, the base particle tank 100 is provided with a drying mechanism. Desirably, the base particle cartridge is also provided with a drying mechanism for the base particle P. When the base particle P in the base particle cartridge is not dried enough, a drying time is provided after the base particle cartridge is installed.

When a plurality of materials are handled in the three-dimensional shaping apparatus 10, the type of the base particle P supplied from the base particle tank 100 is necessary to be changed. Therefore, the base particle tank 100 desirably has a mechanism that makes it possible to easily discharge and clean off the base particle P. This is also applied to the base particle supplying part 200 and the build part 300 described later. The three-dimensional shaping apparatus 10 may be configured so as to include a plurality of the base particle tanks 100, to be able to exchange the base particle tanks 100 according to the type of the base particle P to be used.

Base Particle Supplying Part 200

The base particle supplying part 200 supplies the base particle P necessary for forming the powder layer described later. In the following, two methods will be described as examples of a method of supplying the base particle P by the base particle supplying part 200.

The first method includes: putting the base particle P 220 to be supplied from the base particle tank 100 on the supplying table 211 of the supplying stage 210 of the base particle P; and raising and lowering the supplying stage 210 to supply the base particle P 220. For example, in FIG. 1, the supplying stage 210 is transferred in the direction a, to raise the base particle P 220, and thereafter the powder layer forming part 400 described later is transferred in the direction f, to supply the base particle P 220 to the build part 300. In this method, since the amount of supplying the base particle P to the build part 300 is proportional to the amount of the transfer of raising and lowering of the supplying stage 210, only controlling raising and lowering of the supplying stage 210 makes it possible to easily control the amount of supplying the base material P 220.

When the entire base particle P 220 put on the supplying table 211 is supplied to the build part 300, the supplying stage 210 is transferred in the direction b, and the base particle P 220 is put from the base particle tank 100 onto the supplying table 211 again. In order to complete one cycle of shaping without the base particle P put again, the supplying table 211 is transferred so that the base particle P of a volume necessary for one cycle of shaping is put on the supplying table 211 in advance. It is desirable for a user to operate the operating part 800 described later, to confirm the remaining amount of the base particle P on the supplying table 211. It is also desirable to configure the three-dimensional shaping apparatus 10 so that it is informed a user before the start of shaping that the base particle P is necessary to be put on the supplying table 211 during shaping.

The second method includes: putting the base particle P in a hopper that is provided for the top of the build part 300; and dropping a predetermined amount of the base particle P onto the build part 300 by means of the hopper to supply the base particle P. As structures using a hopper, for example, a transport mechanism to transport the base particle P from the base particle tank 100, and a feeding mechanism to weigh the transported base particle P to feed the base particle P to an auxiliary tank by a predetermined amount are used. Further, the auxiliary tank that includes a screw to level the base particle P along lines, and an open and close mechanism to drop the leveled base particle P onto the build part 300 at a necessary timing are used. Using these structures makes it possible to supply the base particle P to the build part 300. Here, the auxiliary tank and the open and close mechanism may be provided for the powder layer forming part 400 described later so as to be transferable, and may be fixed to the inside of the three-dimensional shaping apparatus 10.

Build Part 300

The build part 300 holds a powder laminate 320 including the shaped article M during shaping, and lowers a powder laminate 322 that is already laminated in order to form a new powder layer 321. The build part 300 includes the build stage 310, the build table 311 and the build chamber 312.

In the build part 300, the powder layers are layered on the build table 311 in order, to perform shaping. For forming the new powder layer 321, first, the build table 311 and the powder laminate 322 put thereon are lowered by a layer pitch. The base particle P supplied from the base particle supplying part 200 is transported to and leveled on the lowered powder laminate 322 by the powder layer forming part 400 described later, to from the new powder layer 321.

When the shaped article M in the powder laminate 320 is heated and solidified after the shaping is completed, the build table 311 and the build chamber 312 are necessary to be configured so as to be transportable. Thus, it is desirable to configure the build table 311 so as to be separable from the build stage 310 when the build stage 310 lowers and the build table 311 comes into contact with the bottom face of the build chamber 312. A material that can be resistant to heat by a heating process to solidify the shaped article M is selected for the build table 311 and the build chamber 312. It is desirable to narrow a gap between the build table 311 and the build chamber 312 enough for the base particle P not to pass therethrough, as long as raising and lowering of the build table 311 are not blocked.

Powder Layer Forming Part 400

The powder layer forming part 400 transports the base particle P put on the base particle supplying part 200 to the build part 300 and levels the transported base particle P, to form the new powder layer 321. The powder layer forming part 400 includes a forming member to be in contact with the base particle P, and a transferring mechanism transferable in the directions e and fin the drawing. The powder layer forming part 400 may also include a raising and lowering mechanism to raise and lower the forming member in order to control the thickness of the powder layer 321 to form.

When the new powder layer 321 is formed, first, the supplying stage 210 is raised, to supply the base particle P from the base particle tank 100 onto the supplying table 211. The build stage 310 is lowered by a layer pitch, to secure a space for forming the powder layer 321 upward the build table 311. Next, the powder layer forming part 400 transfers in the direction f, transports the base particle P supplied on the supplying table 211 toward the build part 300, that is, on the build table 311, and thereafter levels the transported base particle P, to form the powder layer 321. The powder layer forming part 400 continues to transfer in the direction f, and transfers in the direction e after passing by above the build part 300. At this time, the build stage 310 may be raised or the forming member may be lowered, to level the powder layer 321 again. When the powder layer 321 is leveled again by the powder layer forming part 400, the supplying stage 210 is lowered, which makes it possible to collect excessive part of the base particle P which is not used for the powder layer 321, from the build part 300 to the base particle supplying part 200. When the powder layer forming part 400 is transferred in the direction e, the build stage 310 may be lowered or the forming member may be raised so that the forming member of the powder layer forming part 400 is not in contact with the powder layer 321. Since the already laminated powder laminate 322 is formed in the same manner as the powder layer 321, a detailed description thereof is omitted here.

A roller or a squeegee may be preferably used as the forming member. When a roller is used as the forming member, it is recommended to provide a rotating mechanism rotatable in one or both direction(s) for the forming member, to transfer the forming member as rotating the rotating mechanism when the powder layer 321 is formed. Both of a roller and a squeegee may be used, and a plurality of rollers or a plurality of squeegees may be aligned to be used, as the forming member. A different process may be assigned to each part that the forming member is constituted of: for example, a squeegee transports the base particle P, and a roller levels the base particle P. In such structure, the raising and lowering mechanism is provided for at least one of the roller and the squeegee. Desirably, the shapes of a roller and a squeegee are each determined according to the particle diameter and the type of the base particle P. Further, the transfer speed of the forming member and the rotation speed of the rotating mechanism are changed, which can be said to make it possible to realize more stable formation of the powder layer 321.

The powder layer forming part 400 may be configured so as to further have a pressure roller and a pressure plate, to pressurize the powder layer 321. It is expectable that pressurizing the powder layer 321 can increase the number of contact points between particles, which makes it difficult for defects in the shaped article to develop. Pressurizing the powder layer 321 also results in the presence or not of the base particle P in the powder layer 321 more compactly, and as a result, movement of the base particle P during shaping, that is, crumbling of the powder layer 321 is suppressed, which makes it possible to make the shaped article M of high accuracy in the shape. The powder layer 321 is repeatedly formed to laminate the powder layers, which adds the weight of the laminated powder layers to (a) powder layer(s) on a lower position of the build part 300, that is, (a) powder layer(s) closer to the build table 311, to change the density of the base particle P in the layers. Thus, in order to prevent the accuracy of shaping the shaped article from lowering due to the change in the density of the base particle P in the layers, it is desirable to layer a powder layer that does not contain the shaped article and pressurize this powder layer before one cycle of shaping is started.

The base particle P may adhere to the forming member that is to be in contact with the base particle P. Thus, it is desirable to provide for the powder layer forming part 400 a cleaning mechanism to remove the base particle P adhering to the forming member. For example, the cleaning mechanism uses a method of pressing a rubber blade, a brush, or cloth against a surface of the forming member, or a method of spraying a surface of the forming member with water or air. A material and a way that do not damage the forming member are selected for the cleaning mechanism in any method.

Liquid L

The liquid L is applied to the powder laminate 320 according to the shape of the shaped article M, to solidify an applied area in the powder laminate 320. The liquid L is applied to the powder layer 321 everywhen the powder layer 321 is formed, which causes the liquid L to apply to the powder laminate 320 according to the shape of the shaped article M. A binding liquid to bind the base particle P, a particle-dispersed solution in which nanoparticles are dispersed, or the like is preferably used as the liquid L.

As the liquid L, an existing substance can be used, and a substance decomposed by a heating process descried later is more preferably used as a binder to bind the base particle P. Since the liquid L is decomposed by heating, the base particle P in an area to be shaped to which the liquid L is applied can be fixed until a heating process is performed, and the liquid L is hard to become impurities in the shaped article M after the heating process. The binder is specifically from a resin material or a water-soluble carbohydrate. The binder is preferably from a substance soluble in liquid.

When the powder laminate 320 to which the liquid L is applied is solidified by a drying process or heating process, a temperature at which the powder in an area not to be shaped to which the liquid L is not applied is not sintered is selected. For example, when being sintered to solidify the powder laminate 320, particles dispersing in the liquid L are required to have characteristics such as to be able to be sintered at a lower temperature for a shorter time than the base particle P. Here, “sintering” is a process of heating a powder at a temperature not more than the melting point in a state where particles are in contact with each other, to fix (bind) the particles to each other.

The average particle diameter of the particles dispersed in the liquid L of not more than 1 μm makes it possible to sufficiently lower the sintering start temperature of the particles than that of the base particle P even if the particles and the base particle P are the same metal. The average particle diameter of the particles is more preferably not more than 50 nm. This is because a large difference in the sintering temperatures between the particles and the base particle P makes it easy to remove the powder in the area not to be shaped which will be described later. It is better to set the average particle diameter of the particles so that the particles easily come into gaps among the base particle P when the liquid L is applied. Using the metal same as the base particle P as the material of the particles can reduce the amount of impurities in the shaped article M.

Liquid Applying Part 500

The liquid applying part 500 applies the liquid L to the powder laminate 320 according to slice data of the shaped article M. Applying the liquid L to the powder laminate 320 according to the shape of the shaped article M makes it possible to solidify the area to form the shaped article M in the powder laminate 320. The liquid applying part 500 applies the liquid L everywhen the powder layer 321 is formed. Repeating this makes it possible to apply the liquid L to the powder laminate 320 according to the shape of the shaped article M.

The liquid applying part 500 includes the liquid applying heads 510, the liquid auxiliary tanks 520 and the liquid tanks 530. The liquid applying part 500 is provided with a transferring mechanism transferable in the directions i and j in the drawing. The independent liquid applying heads 510 whose number is the same as inks (4 in FIG. 1) are arranged in the transferring direction of the transferring mechanism. In the present embodiment, the liquid L is used as a general term of a plurality of inks.

The liquid applying part 500 functions as a liquid applying means. The liquid applying part 500 transfers in the directions i and j to scan the powder layer 321 using the liquid applying heads 510 as a liquid ejecting part, and applies the liquid L from the liquid applying heads 510 to the powder layer 321. The liquid applying part 500 causes the liquid applying heads 510 to eject the liquid L according to the slice data of the shaped article M. Here, the liquid applying part 500 may apply the liquid L to the powder layer 321 from the liquid applying heads 510 only when transferring in one of the directions i and j. A timing when the liquid L is ejected from the liquid applying heads 510 may be determined based on an output signal from an encoder for transfer of the liquid applying part 500.

The liquid tanks 530 are provided for inks ejected from the liquid applying heads 510 respectively. The same ink may be stored in different liquid tanks 530. The inks stored in the liquid tanks 530 are fed to the liquid auxiliary tanks 520 by tubes, and thereafter fed to the liquid applying heads 510. The pressure in the liquid auxiliary tanks 520 is controlled so as to prevent the liquid from leaking out of the liquid applying heads 510, and to pressurize to remove nozzle clogging. Each of the liquid applying heads 510 includes a line head aligning in the transfer direction of the liquid applying part 500. Each of the line heads may be formed by a seamless single nozzle tip, or by divided nozzle tips regularly aligned in one line or a staggered arrangement. In the present embodiment, a so-called full-multi head such that nozzles align within a range covering one side of the area to be shaped in the powder laminate 320 is employed for the line heads. When the area to be shaped sticks out of the width of the line heads, a mechanism to transfer the line heads by one more axis may be provided to apply the liquid L a plurality of times. The liquid applying part 500 can apply the liquid L to the same place a plurality of times, to control the concentration of the liquid L applied to the powder layer 321.

The liquid applying part 500 may be a mechanism that can apply the liquid L of a desired amount to a desired position. In view of control over the amount of the liquid and the position where the liquid is applied with high accuracy, a mechanism by an inkjet system is preferably used. As the inkjet system of ejecting ink from a nozzle, a system using a heating element, a system using a piezoelectric element, a system using an electrostatic element, a system using a MEMS element, or the like is preferably used. Instead of the inkjet system, any of printing systems such as a (dye-sublimation or thermal transfer) thermal printer, a dot matrix printer, a LED printer, and a laser printer may be used.

When the liquid L is ejected using a mechanism by the inkjet system, the viscosity of the liquid L described later is preferably not more than 50 cP, and more preferably not more than 20 cP. Here, the viscosity of the liquid L is preferably not more than 20 cP in order to diffuse the liquid L among the base particle P more rapidly when the liquid L is applied to the powder layer 321, and in order to more easily aggregate the liquid L among the base particle P in a drying process of the liquid L. It is expectable that the viscosity of the liquid L of not more than 20 cP makes it easier to control ejecting of the liquid L from the liquid applying heads 510.

Desirably, a mechanism to prevent an phenomenon such that inks are not ejected from the liquid applying heads 510 is provided for the liquid applying part 500. This mechanism is specifically a cleaning mechanism to wipe away vapor, mist, and/or an excessive ink adhering to the liquid applying heads 510. A member made from a material such as a silicone rubber and a cloth is preferably used for the cleaning mechanism so as not to damage the liquid applying heads 510. More preferably, a part abutting the liquid applying heads 510 is desirably damp due to water, a dedicated cleaning agent, or the like.

Drying Part 600

The drying part 600 dries up the liquid L applied to the powder laminate 320 by the liquid applying part 500. As the drying method by the drying part 600, drying by heating, a method of spraying dried air, or the like may be used. The drying process is preferably performed everywhen one powder layer 321 is formed. When the liquid L is applied a plurality of times to one powder layer 321, the drying process may be performed everywhen the liquid L is applied. In the drying process by the drying part 600, operational parameters such as power and time may be determined according to the concentration and the amount of the liquid L applied to the powder layer 321, and kinds of inks.

In the present embodiment, a line heater that covers the area to be shaped in the build part 300 is employed. The drying part 600 drives the line heater, to perform the drying process on the area to be shaped in the powder layer 321. When such structure is employed, the drying part 600 can perform the drying process at the same time as the powder layer forming part 400 or the liquid applying part 500 operates. For example, the drying part 600 is provided for the same transferring mechanism, for which the liquid applying part 500 is provided, which makes it possible for the drying part 600 to perform the drying process following application of the liquid L to the powder layer 321 by the liquid applying part 500. The drying part 600 is provided for the same transferring mechanism, for which the liquid applying part 400 is provided, which also makes it possible for the drying part 600 to perform the drying process following formation of the powder layer 321 by the powder layer forming part 400. Further, when a planar heater is employed instead of the line heater of the drying part 600, the entire area to be shaped can be dried once without the drying part 600 transferred.

Desirably, the drying part 600 changes the amount of heat applied to the liquid L in the drying process according to the amount of the liquid L applied to the powder layer 321 by the liquid applying part 500. Further, a local drying process only on an area to which the liquid L is applied in the powder layer 321 can shorten the shaping time, to suppress a temperature rise in the powder layer 321. The forgoing local drying process by the drying part 600 is also effective for preventing a phenomenon such that a temperature rise in the powder layer 321 causes the liquid applying heads 510 passing by above the powder layer 321 to dry and/or not to eject inks.

Controlling Part 700

The controlling part 700 controls each part of the three-dimensional shaping apparatus 10. The controlling part 700 can be realized by, for example, a control circuit or an information processor. The information processor includes a PC having computing resources such as a CPU and a memory and operating according to programs and input data.

The controlling part 700 controls the foregoing operations of various kinds based on operations of the operating part 800 by a user of the three-dimensional shaping apparatus 10, which will be described later. Specifically, the controlling part 700 controls transportation of the base particle P from the base particle tank 100 to the base particle supplying part 200, raising and lowering of the base particle supplying part 200 and the build part 300, transfer of the powder layer forming part 400 and the liquid applying part 500, ejection of the liquid L, drying by the drying part 600, etc. The controlling part 700 may be configured so as to automatically take control based on requirements stored in the memory in advance, other than operations of the operating part 800. For example, the controlling part 700 may make the base particle P transported from the base particle tank 100 to the base particle supplying part 200 according to instructions based on operations of the operating part 800, or based on the remaining amount of the base particle P detected thereby in the three-dimensional shaping apparatus 10.

Parameters used for control by the controlling part 700 may be inputted by user's operations of the operating part 800. Or, the controlling part 700 may determine parameters based on types of powders used for formation of the powder laminate 320, the average particle diameter of the base particle P, the type of the liquid L, and information contained in slice data used for formation of the shaped article M etc. The controlling part 700 may determine the foregoing parameters based on correspondence between the foregoing information stored in the memory in advance and the parameters.

In the present embodiment, the controlling part 700 determines whether the area to be shaped is present in one powder layer 321, and if determining that the area to be shaped is not present in the powder layer 321, changes control over each part of the three-dimensional shaping apparatus 10. One example of the change in control include to stop scanning of the powder layer 321 of the liquid applying heads 510 by the liquid applying part 500. This is because even if the same processing as the shaping processing performed on a powder layer determined that the area to be shaped is present therein is performed on a powder layer determined that the area to be shaped is not present therein, the processing does not directly affect the accuracy of shaping the shaped article.

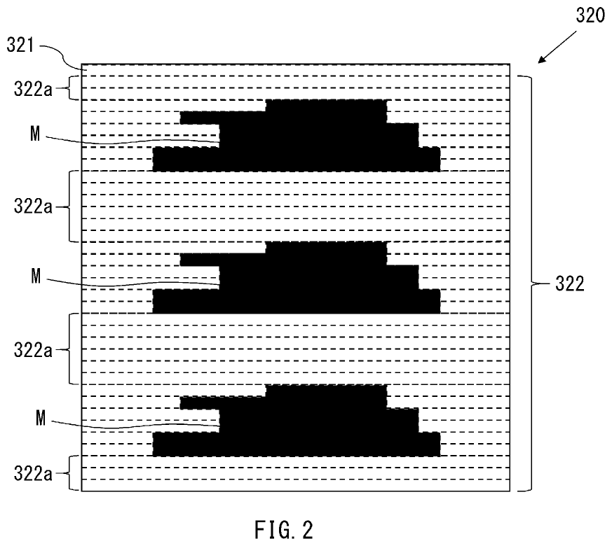

FIG. 2 schematically shows the powder laminate 320 in which the shaped article M is formed by the three-dimensional shaping apparatus 10. FIG. 2 shows one powder layer 321, and the powder laminate 322, which is formed and laminated before the powder layer 321 is formed. In FIG. 2, one rectangular area surrounded by solid lines and dotted lines shows one powder layer. In FIG. 2, the powder layer 321 and powder laminates 322a are powder layers determined that the area to be shaped in which the shaped article M is formed is not present therein. Here, the powder layers determined that the area to be shaped is not present therein generally include a space among a plurality of shaped articles in the powder laminate 320 laminated in one cycle of shaping, and any powder layers occupying a space between the shaped article and the build table 311.

The controlling part 700 may further change shaping parameters if determining that the area to be shaped is not present in a powder layer. For example, the controlling part 700 may increase the speed of the powder layer forming part 400, and may change the amount of heat outputted by the drying part 600 and the drying time since the shaped article is not formed in that powder layer. These steps of processing are automatically performed by the controlling part 700. Desirably, a user of the three-dimensional shaping apparatus 10 can operate the operating part 800, to identify a powder layer, processing on which is changed by the controlling part 700.

As a method of determining whether or not the area to be shaped is present in the powder layer 321, for example, determination can be made based on the area size of the area to which the liquid L is applied in the powder layer 321. The area size of the area to which the liquid L is applied in the powder layer 321 can be identified based on information contained in slice data corresponding to the powder layer 321. When the size of the area to which the liquid L is applied is used as a criterion, whether the size of the area to which the liquid L is applied in the powder layer 321 is 0 or not may be used as a criterion, and the result of a comparison between the size of the applied area and a preset threshold value may be used as a criterion. When the size of the area to which the liquid L is applied in the powder layer 321 is calculated, the amount of the liquid L ejected to an area other than the area to be shaped may be excluded. This is for ignoring the amount of the liquid L ejected irrelevantly to the presence or not of the area to be shaped in order to prevent the liquid L from not being ejected and in order to protect the liquid applying heads 510 when the size of the area to which the liquid L is applied is calculated. Instead of calculation of the size of the area to which the liquid L is applied, the amount of the liquid L applied to the powder layer 321 may be calculated to determine whether the area to be shaped is present or not based on the calculated amount, which can be preferably used when the three-dimensional shaping apparatus 10 obtains the slice data from the outside since the amount of the liquid L applied to the powder layer 321 can be calculated using the slice data.

When the three-dimensional data of the shaped article is inverted to slice data, formation or not of the shaped article in each powder layer may be stored to determine, based on this, whether the area to be shaped is present or not in the powder layer 321 everywhen the powder layer 321 is formed on the build table 311. This method makes it possible to detect in advance that the powder layer 321 determined that the area to be shaped is not present therein is continuously formed, in the three-dimensional shaping apparatus 10, based on slice data of a plurality of the powder layers. In the three-dimensional shaping apparatus 10, special processing can be set to be performed as well when the powder layer 321 determined that the area to be shaped is not present therein is continuously formed. Examples of the special processing here include processing of omitting driving of the liquid applying part 500 and/or the drying part 600.

Further, the three-dimensional shaping apparatus 10 can identify in advance how many powder layers 321 determined that the area to be shaped is not present therein are continuously present. This makes it possible for the three-dimensional shaping apparatus 10 to, for example, calculate time required for shaping processing on each of a powder layer determined that the area to be shaped is present therein, and a powder layer determined that the area to be shaped is not present therein, to calculate time for completing shaping more accurately.

Operating Part 800

The operating part 800 is operated by a user of the three-dimensional shaping apparatus 10 to instruct the start to shaping the shaped article M, and to change the shaping parameters. The operating part 800 may be operated by a user to instruct that the shaping is broken and resumed, that each part of the three-dimensional shaping apparatus 10 is individually driven, etc. The operating part 800 may be configured so as to do maintenance such as cleaning of the powder layer forming part 400, and cleaning of the applying heads 510. The operating part 800 may be configured so as to inform a user of a state of shaping such that how many layers of the powder laminate 320 on which the shaping processing is completed, and conditions of the apparatus such as the remaining amount of the base particle P and the remaining amount of inks.

Further, a display part for a user to confirm these pieces of information may be separately provided for the three-dimensional shaping apparatus 10.

The operating part 800 is preferably configured so that a user can input and output the shaping parameters thereinto and therefrom. The operating part 800 may be configured so that a user can operate the operating part 800 to select any of a plurality of patterns each including a plurality of shaping parameters in combination which are made by the three-dimensional shaping apparatus 10 in advance. The three-dimensional shaping apparatus 10 may be configured so as to automatically select the patterns made here based on the type and the average particle diameter of the base particle P, the type of the liquid L, etc. In this case, the operating part 800 is preferably configured so that a user can operate the operating part 800 to designate the base particle P and the liquid L.

Further, the three-dimensional shaping apparatus 10 may be configured so that a user can operate the operating part 800 to change parameters while the shaping processing of the shaped article M is executed. Particularly, the three-dimensional shaping apparatus 10 may be desirably configured such that a user can change the supply amount from the particle supplying part 200, the transfer speed of the powder layer forming part 400, the power of the drying part 600, etc. while checking the state of shaping of the shaped article M.

Shaping Flow

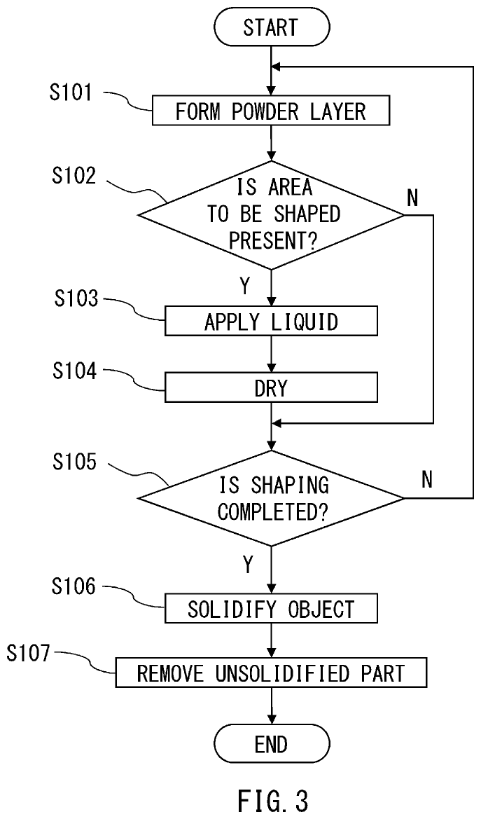

Next, processing executed by the controlling part 700 of the three-dimensional shaping apparatus 10 will be described with reference to the flowchart shown in FIG. 3. It is noted that slice data corresponding to each layer of the powder laminate formed on the build stage 310 is made from the three-dimensional shape data of the shaped article M by the three-dimensional shaping apparatus 10 (such as a personal computer) before shaping of the shaped article M to be shaped is started. As the three-dimensional shape data, data made by a three-dimensional CAD, a three-dimensional modeler, a three-dimensional scanner, or the like can be used, and for example, a STL file can be preferably used. The slice data is data obtained by slicing a three-dimensional shape of the shaped article by a given interval (thickness), and containing information indicating shapes of cross sections of the shaped article, thicknesses of powder layers, arrangements of materials, etc. Thicknesses of powder layers are preferably determined according to required shaping accuracy, and the average particle diameter of powders used for shaping since affecting the accuracy of shaping the shaped article. Step S102 shown in FIG. 3 is one example of a determining step of determining whether the area to be shaped is present or not in a powder layer based on the three-dimensional data. Steps S101 to S105 shown in FIG. 3 show one example of a controlling step of controlling a powder layer forming step and a liquid applying step such that formation of a powder layer and application of the liquid are repeated to form the shaped article in the laminated powder laminate.

In a preparatory stage of shaping of the shaped article M, the base particle P is packed to the base particle tank 100, and the liquid L is packed to the liquid tanks 530. The base particle P packed to the base particle tank 100 is transported to the base particle supplying part 200. The supplying stage 210 and the build stage 310 are raised and lowered, to transfer the supplying table 211 and the build table 311 to the initial positions. One example of transfer of each table to the initial position include transfer of the supplying table 211 to the lowest position within a transferrable range in the base particle supplying part 200, and transfer of the build table 311 to the highest position within a transferrable range in the build part 300. Transfer of each table to such an initial position makes it possible to shaping a shaped article of the largest size among sizes of the shaped article which can be shaped at once. The initial position of each table may be changed according to the size of the shaped article. The controlling part 700 may be configured so as to confirm whether the base particle P and the liquid L necessary for shaping are packed to the base particle tank 100 and the liquid tanks 530 respectively when shaping is started. The controlling part 700 is preferably configured so as to inform a user via the operating part 800 of the case where the packing amount of the base particle P or the liquid L is insufficient if so.

When a powder layer is not in a closely packed state, the shape of the powder layer may be unstable. Thus, a powder layer is preferably formed plural times on the build table 311 in advance before the start of the shaping. Further, operations such as heating and drying are preferably carried out in advance for more stable temperature control when the powder laminate is heated and dried. Likewise, the operation of applying the liquid L by the liquid applying part 500 is preferably performed in advance in order to stably apply the liquid L to the powder laminate. It is known that the amount of ejecting the liquid L by the liquid applying part 500 varies according to the temperature and conditions of the liquid applying heads 510. Thus, the amount of ejecting the liquid L by the liquid applying part 500 is preferably measured before the start of shaping and/or after completion of shaping, to do maintenance including adjustment of the amount of ejection as necessary. Here, measurement of the amount of ejecting the liquid L by the liquid applying part 500, and maintenance of the liquid applying part 500 can be realized using a well-known technique.

The controlling part 700 of the three-dimensional shaping apparatus 10 forms a powder layer on the build table 311 of the build part 300 in S101. The formed powder layer is as thick as possible as long as satisfying necessary shaping accuracy, which can shorten the shaping time. The amount of the base particle P supplied from the base particle supplying part 200 to the build part 300 is set in an amount at least twice as much as the volume of the formed powder layer, which makes it possible to more stably form the powder layer. When the powder layer forming part 400 transfers the base particle P to the build part 300, some of the base particle P not reaching the build part 300 may exist. The supply amount of the base particle P is thus set as the foregoing for the purpose of reducing the influence of the amount of the base particle P not reaching the build part 300 as described above on formation of a powder layer on the build part 300.

Next, in S102, the controlling part 700 functions as a determining means, to determine whether the area to be shaped is present or not in the formed powder layer. In the method of determining whether the area to be shaped is present or not in the formed powder layer, for example, the size of an area to which the liquid L is applied in the powder layer can be used as a criterion. Information indicating the presence or not of the shaped article which is contained in the slice data when the three-dimensional data of the shaped article is converted into the slice data may be also used as a criterion. If the controlling part 700 determines that the area to be shaped is present in the powder layer formed in S101 (S102: Y), the processing goes on to S103. In contrast, if the controlling part 700 determines that the area to be shaped is not present in the powder layer formed in S101 (S102: N), the processing goes on to S105.

In S103, the controlling part 700 controls the liquid applying part 500 to scan the powder layer by the liquid application head 511, and applies the liquid L to the powder layer according to the slice data of the shaped article. The applied liquid L is for selectively solidifying the shaped article in powder layers in S105 descried later. The slice data of the shaped article which is made in advance may be used, and the slice data may be suitably made by the controlling part 700 during shaping of the shaped article. The amount of applying the liquid L per unit area of the area to be shaped or unit volume of the shaped article may be the same for each piece of slice data, and may be adjusted step by step.

Next, in S104, the controlling part 700 controls the drying part 600 to carry out a step of drying the liquid L applied to the powder layer in S103. Here, the purposes of drying the liquid L include to increase the concentration of components contained in the liquid L, and to prevent a phenomenon such that the liquid L penetrates the outside of the area to be shaped. Drying the liquid L can suppress change in flowability of powders in the area to be shaped in the powder laminate laminated under a new powder layer when the new powder layer is formed by processing in next step S101. As the method of drying the liquid L in S103, a method such as heating the powder layer by a heater, and spraying the powder layer with dried air by an air drier is preferably used. The processing time of the drying step, and various outputs of the drying part 600 in S103 are preferably changed according to the amount of the applied liquid L.

In S105, the controlling part 700 determines whether shaping of the shaped article M in the powder laminate 320 is completed or not. The controlling part 700 determines whether shaping of the shaped article M is completed or not based on, for example, the presence or not of unused slice data. If the controlling part 700 determines that shaping of the shaped article M is not completed (S105: N), the processing is returned to S101, and a new powder layer is formed. In contrast, if the controlling part 700 determines that shaping of the shaped article M is completed (S105: Y), the processing goes on to S106. The controlling part 700 may control the base particle supplying part 200 and the build part 300 after this flowchart is ended, that is, after one cycle of shaping is completed, to form one layer or plurality of powder layers which does or do not contain the shaped article. This makes it possible for the controlling part 700 to use the formed powder layer(s) for next shaping.

Next, in S106, the controlling part 700 controls the drying part 600 to scan the powder layer by the drying part 600, and selectively solidifies the area to be shaped to which the liquid L is applied in S103. As the method of solidifying the area to be shaped in S106, the same method as in S104 can be used.

Next, in S107, the controlling part 700 removes a part of an area not to be shaped (unsolidified part) which is not solidified in S106 in the powder layer formed in S101, to take out the shaped article. Examples of the method of removing the unsolidified part in S107 include a method of removing powders using a brush or air.

As described above, according to the present embodiment, whether the area to be shaped is present or not in the powder layer is determined in the three-dimensional shaping apparatus 10, and if it is determined that the area to be shaped is not present (S102: N), scanning by the liquid application head 511 and application of the liquid L (step S103) are omitted. Further, in this case, scanning and drying by the drying part 600 (step S104) are omitted. As described above, based on the determination, control in the powder layer forming step and the liquid applying step in each repeat of formation of a powder layer and application of the liquid is changed. This makes it possible to omit steps necessary for the area to be shaped on the powder layer determined that the area to be shaped is not present therein, which makes it possible to shorten the time required for shaping, to speed up shaping more. The foregoing description of the flowchart is just an example of basic steps in the shaping method of the present embodiment, and the present disclosure is not limited to the foregoing description. That is, each of the contents and orders in the foregoing processing may be suitably changed, and any step other than the foregoing may be added.

For example, a step of heating the shaped article M at a higher temperature than that used for solidifying the area to be shaped in S106 may be provided after step S107. Heating the shaped article under the conditions (such as heating temperature and heating time) for sintering the base particle P can further improve the density and strength of the shaped article.

### Second Embodiment

The structure of the three-dimensional shaping apparatus in the second embodiment is almost the same as the first embodiment, and thus different parts from the first embodiment will be mainly described. In the following description, the same reference signs will be added to the structures and steps same as in the first embodiment, and detailed descriptions thereof will be omitted. In the three-dimensional shaping apparatus of the second embodiment, shaping processing when a powder layer determined that the area to be shaped is not present therein is continuously laminated is changed.

Controlling Part 700

In the present embodiment, the controlling part 700 of the three-dimensional shaping apparatus 10 regards continuous powder layers as one powder layer, to perform shaping processing (batch processing) when at least two powder layers which are determined that the area to be shaped is not present therein are continuously layered.

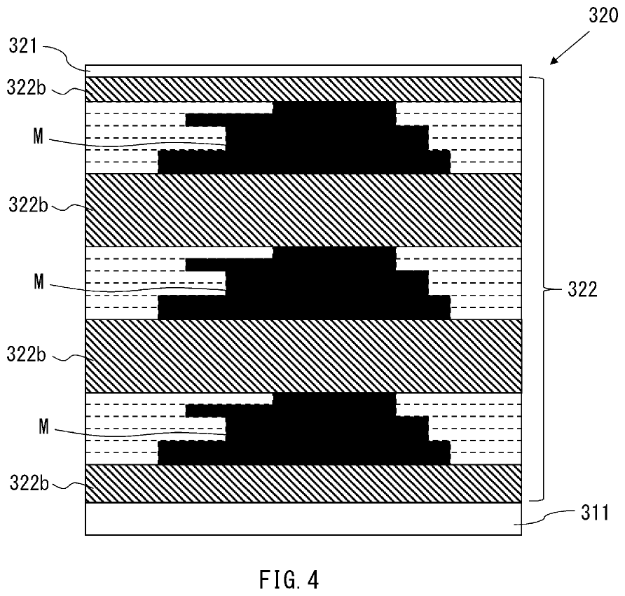

In FIG. 4, each of the powder laminates 322a of a plurality of continuous layers determined that the area to be shaped is not present therein in FIG. 2 is shown as one powder layer 322b as a whole. As shown in FIG. 4, each of the powder layer 322b is present between a plurality of the shaped articles M in the powder laminate 320, and between the shaped article M and the build table 311, in the powder laminate 320 laminated on the build table 311. The reason why the powder layer 322b is present as described above is because the powder layer 322b intervenes in the shaped articles M in the powder laminate 320, to prevent influence of the shaped articles M on each other in the foregoing shaping processing. Desirably, the shaped articles M are usually present in the powder laminate 320 at intervals of at least 1 mm. This interval is very large compared to the thickness of one general powder layer (layer pitch).

In the present embodiment, shaping processing is performed on a plurality of continuous powder layers altogether which are determined that the area to be shaped is not present therein, which makes it possible to layer the powder layers between the shaped articles M for a shorter time. Here, each one of a plurality of the continuous powder layers which are determined that the area to be shaped is not present corresponds to one piece of the slice data. In the present embodiment, plural pieces of the slice data corresponding to these plurality of the powder layers may be regarded as one piece of the slice data, and a plurality of the continuous powder layers which are determined that the area to be shaped is not present therein may be regarded as a single powder layer. That is, in the three-dimensional shaping apparatus 10, the controlling part 700 may use a larger layer pitch for a plurality of the continuous powder layers which are determined that the area to be shaped is not present therein than a layer pitch for a powder layer determined that the area to be shaped is present therein.

When the controlling part 700 performs shaping processing altogether on a plurality of the continuous powder layers which are determined that the area to be shaped is not present therein, all the continuous powder layers are not necessarily formed at once. For example, when at least ten continuous powder layers which are determined that the area to be shaped is not present therein, the controlling part 700 preferably forms the powder layers a plurality of times. The reason why shaping processing is performed as described above is to prevent a large change in the temperature and the packing factor of each powder layer due to change in the layer pitch of the formed powder layer. When a formed powder layer, a powder layer just above or just under which is determined that the area to be shaped is present therein is layered, the layered powder layer is preferably formed not by the foregoing batch processing but by individual steps of processing. The reason why the powder layer is formed as described above is because a step of forming the powder layer may indirectly affect formation of a powder layer just above or just below which is determined that the area to be shaped is present therein.

Shaping Flow

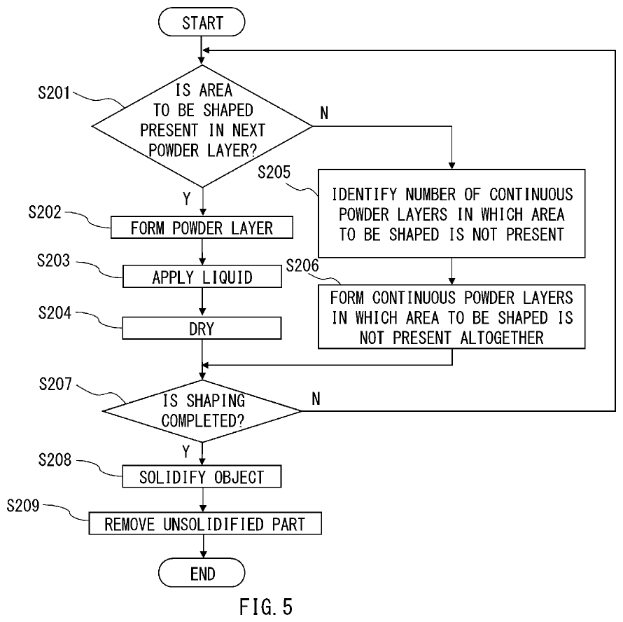

Next, processing executed by the controlling part 700 of the three-dimensional shaping apparatus 10 according to the present embodiment will be described with reference to the flowchart shown in FIG. 5.

In S201, the controlling part 700 determines whether or not the area to be shaped is present in the powder layer 321 based on the slice data before the new powder layer 321 is formed on the build table 311. If the controlling part 700 determines that the area to be shaped is present in the powder layer 321 (S201: Y), the processing goes on to S202. In contrast, if the controlling part 700 determines that the area to be shaped is not present in the powder layer 321, the processing goes on to S205.

In S205, the controlling part 700 identifies the number of continuous powder layers determined that the area to be shaped is not present therein, in powder layers formed after the powder layer 321 determined that the area to be shaped is not present therein in S201 based on the slice data. In S205, the controlling part 700 may identify the entire thickness of all the continuous powder layers determined that the area to be shaped is not present therein instead of identifying the number of continuous powder layers determined that the area to be shaped is not present therein. That is, the controlling part 700 may identify a distance from the shaped article formed in the powder layer just under the powder layer 321 to the shaped article planned to be formed next.

Next, in S206, the controlling part 700 controls the base particle supplying part 200, the build part 300, and the powder layer forming part 400, to perform a formation step altogether on the continuous powder layers determined that the area to be shaped is not present therein, whose number is identified in S205. The controlling part 700 does not necessarily form the powder layers to be processed altogether at once. As described above, individual forming steps are desirably performed on a powder layer, just above or just under a powder layer of which the area to be shaped is present therein, among the powder layers to be processed altogether. As described above, in the second embodiment, the controlling part 700 changes the thickness of the powder layer formed by the base particle supplying part 200, the build part 300, and the powder layer forming part 400 as powder layer forming means, as change in control. The controlling part 700 makes the processing go on to S207 after step S206 is completed.

Steps S202, S203, S204, S207, S208 and S209 are the same as steps S101, S103, S104, S105, S106 and S107 in the first embodiment respectively, and thus detailed descriptions thereof are omitted here.

As described above, in the second embodiment, the controlling part 700 of the three-dimensional shaping apparatus 10 forms powder layers altogether when the continuous powder layer determined that the area to be shaped is not present therein exit. This makes it possible to transfer the base particle P from the supplying table 211 to the build table 311, and to transfer the supplying table 211 and the build table 311 at once by a plurality of layers, that is, to more shorten a time required for processing and speed up shaping more than the case where powder layers are formed one by one.

As well as in the first embodiment, the foregoing description of the flowchart is just an example of basic steps in the shaping method of the second embodiment, and the present disclosure is not limited to the foregoing description. That is, each of the contents and orders of the foregoing processing may be suitably changed, and any step other than the foregoing may be added. For example, the step of applying and drying up the liquid may be performed on a powder layer determined that the area to be shaped is not present therein. In the batch processing in S206, the shaping parameters may be suitably changed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure is used for three-dimensional shaping apparatuses, and particularly can be used for three-dimensional shaping apparatuses to perform three-dimensional shaping using a powder of a base particle.

According to the present disclosure, control over a means to form a shaped article is changed for a powder layer not including the shaped article, which can achieve a shortened shaping time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-118700, filed on Jun. 26, 2019, which is hereby incorporated by reference herein in its entirety.

What is claimed is:

1. A three-dimensional shaping apparatus comprising:
a powder layer forming part configured to form a powder layer made from base particles;
a liquid applying part configured to apply liquid to bind the base particles to an area to be shaped in the powder layer in which a shaped article is formed based on three-dimensional data of the shaped article;
a controlling part configured to control the powder layer forming part and the liquid applying part to repeat formation of the powder layer and application of the liquid to form the shaped article in laminated powder layers; and
a determining part configured to determine based on the three-dimensional data in each repeat of the formation of the powder layer and the application of the liquid whether the area to be shaped is present in the powder layer,
wherein the controlling part changes control over the powder layer forming part and the liquid applying part based on determination by the determining part in each repeat of the formation of the powder layer and the application of the liquid.

2. The three-dimensional shaping apparatus according to claim 1, wherein the control is control of a thickness of the powder layer formed by the powder layer forming part.

3. The three-dimensional shaping apparatus according to claim 1, wherein
the liquid applying part performs scanning of the powder layer by a liquid application head configured to applying the liquid thereto, and
the control is stop of the scanning of the powder layer by the liquid application head.

4. The three-dimensional shaping apparatus according to claim 1, further comprising:
a drying part configured to dry the liquid applied to the powder layer,
wherein the controlling part changes control over an amount of heat applied to the liquid by the drying part or drying time for drying the liquid by the drying part based on the determination by the determining part.

5. The three-dimensional shaping apparatus according to claim 1, wherein the controlling part calculates time for completing shaping of the shaped article in the powder layer based on a number of powder layers determined by the determining part that an area to be shaped is not present therein and the control changed over the powder layers determined by the determining part that an area to be shaped is not present therein.

6. The three-dimensional shaping apparatus according to claim 1, wherein
the three-dimensional data includes a plurality of pieces of slice data, and
the determining part determines a size of an area in the powder layer corresponding to the slice data to which the liquid is applied based on the slice data and determines whether the area to be shaped is present in the powder layer based on the size of the area determined by the determining part.

7. The three-dimensional shaping apparatus according to claim 1, wherein
the three-dimensional data includes a plurality of pieces of slice data, and
the slice data includes information indicating presence or not of a shaped article in the powder layer corresponding to the slice data, and
the determining part determines whether the area to be shaped is present in the powder layer based on the information.

8. A three-dimensional shaping method comprising:
a powder layer forming step of forming a powder layer made from base particles;
a liquid applying step of applying liquid to bind the base particles to an area to be shaped in the powder layer in which a shaped article is formed based on three-dimensional data of the shaped article;
a controlling step of controlling the powder layer forming step and the liquid applying step to repeat formation of the powder layer and application of the liquid to form the shaped article in laminated powder layers; and
a determining step of determining based on the three-dimensional data in each repeat of the formation of the powder layer and the application of the liquid whether the area to be shaped is present in the powder layer,
wherein the controlling step changes control over the powder layer forming step and the liquid applying step based on a determination by the determining step in each repeat of the formation of the powder layer and the application of the liquid.

9. A non-transitory computer readable storage medium having a program stored therein, the program causing a computer to execute:
a powder layer forming step of forming a powder layer made from base particles;
a liquid applying step of applying liquid to bind the base particles to an area to be shaped in the powder layer in which a shaped article is formed based on three-dimensional data of the shaped article;
a controlling step of controlling the powder layer forming step and the liquid applying step to repeat formation of the powder layer and application of the liquid to form the shaped article in laminated powder layers; and
a determining step of determining based on the three-dimensional data in each repeat of the formation of the powder layer and the application of the liquid whether the area to be shaped is present in the powder layer,
wherein the controlling step changes control over the powder layer forming step and the liquid applying step based on a determination by the determining step in each repeat of the formation of the powder layer and the application of the liquid.
